(19) United States
(12) Patent Application Publication
(10) Pub. No.: US 2009/0119311 A1
(43) Pub. Date: May 7, 2009

(54) SYSTEMS, METHODS, AND COMPUTER PRODUCTS FOR IN-PLACE MODEL ATTRIBUTE COMPARISON

(75) Inventors: Sandeep Kohli, Bangalore (IN); Sudhakar Pasupunuri, Bangalore (IN)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/935,892

(22) Filed: Nov. 6, 2007

(51) Int. Cl. G06F 17/30; G06F 3/048

(52) U.S. Cl. 707/100; 715/781; 707/E17.001

(57) ABSTRACT

Systems, methods and computer products for comparing computer models to show differences. Exemplary embodiments include a method for examining changes to a data model in a computer system having a keyboard and a display, the method including examining a computer model having a plurality of model attributes, identifying each model attribute and assigning a unique identifier to each model attribute, storing information about each uniquely identified model attribute, collecting data related to edits performed on of each of the uniquely identified model attributes, providing a user selectable comparison for each of the uniquely identified model attributes such that when a model attribute is selected, data particular to the model attribute is extracted using the unique identifier from a previous iteration of the model attribute and presenting the extracted data next to the current iteration of the model attribute to allow a visual comparison of the two iterations.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a model compare utility, and particularly to a systems, methods and computer products for comparing computer models to show differences.

2. Description of Background

At present it is difficult to compare individual elements of a computer model. Most computer model compare utilities can only show differences between two entire Unified Modeling Language (UML) utility models only. Therefore, the user has to navigate the provided list of differences to find the model element of interest. If the model is big and the changes are numerous, navigating to a particular element can be a tedious job. To see the difference of a single element in a large model, the user has to leave their current integrated digital environment (IDE), to use an external utility that requires additional time and effort. Furthermore, current solution utilize the concept of file by file differences, whereas in a UML tool, a user is more interested in seeing the differences between a particular model element versus a previous version, rather the entire file.

Based on the foregoing, there exists a need for UML tool that shows differences between the elements of interest only, without leaving the current IDE or opening up any external tools.

### SUMMARY OF THE INVENTION

Exemplary embodiments include a method for examining changes to a data model in a computer system having a keyboard and a display, the method including examining a computer model having a plurality of model attributes, identifying each model attribute and assigning a unique identifier to each model attribute, storing information about each uniquely identified model attribute, collecting data related to edits performed on of each of the uniquely identified model attributes, providing a user selectable comparison for each of the uniquely identified model attributes such that when a model attribute is selected, data particular to the model attribute is extracted using the unique identifier from a previous iteration of the model attribute and presenting the extracted data next to the current iteration of the model attribute to allow a visual comparison of the two iterations.

Further exemplary embodiments include a system for examining changes to a data model, the system including a computing device having a keyboard, a display and a memory having instructions to, examine a computer model on the display, the computer model having a plurality of model attributes, identify each model attribute and assigning a unique identifier to each model attribute, store data about each uniquely identified model attribute in the memory, collect data related to edits performed on of each of the uniquely identified model attributes, provide a user selectable comparison for each of the uniquely identified model attributes such that when a model attribute is selected, data particular to the model attribute is extracted using the unique identifier from a previous iteration of the model attribute, the user selectable comparison being performed by depressing a hot key combination on the keyboard to display a differences window on the display and present the extracted data next to the current iteration of the model attribute to allow a visual comparison of the two iterations, the comparison being displayed in the differences window.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides a user with a comparison environment that can be displayed concurrently with the modeling environment providing an in-place comparison for a quick view of the differences. In addition, the user can replace a model element with the older version. The comparison tool can be used over a UML diagram to show the previous version of the diagram.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary system 100 for in-place model attribute comparison.

FIG. 2 illustrates a class diagram prior to a modification in accordance with exemplary embodiments;

FIG. 3 illustrates a class diagram after modifications in accordance with exemplary embodiments;

FIG. 4 illustrates the Final Version Class diagram of FIG. 2 with a differences window illustrating the differences between the Initial Version of FIG. 1 and the Final Version of FIG. 2 in accordance with exemplary embodiments; and

FIG. 5 illustrates an overall method for performing an in-place comparison in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments include systems, methods and computer products for examining changes to computer models. The exemplary embodiments described herein provide a framework to represent any form of model of unlimited complexity in a generalized, repeatable format such that a “snapshot” of models can be taken, models can be compared, differences determined, and identified changes implemented into instances of a model. As an example, PowerPoint® is described. In PowerPoint®, a “tool->compare and merge documents” is invoked for document comparison. In this example, this tool compares an opened file with a selected file. This comparison is a complete file-to-file comparison, and all the differences between the two documents are listed.

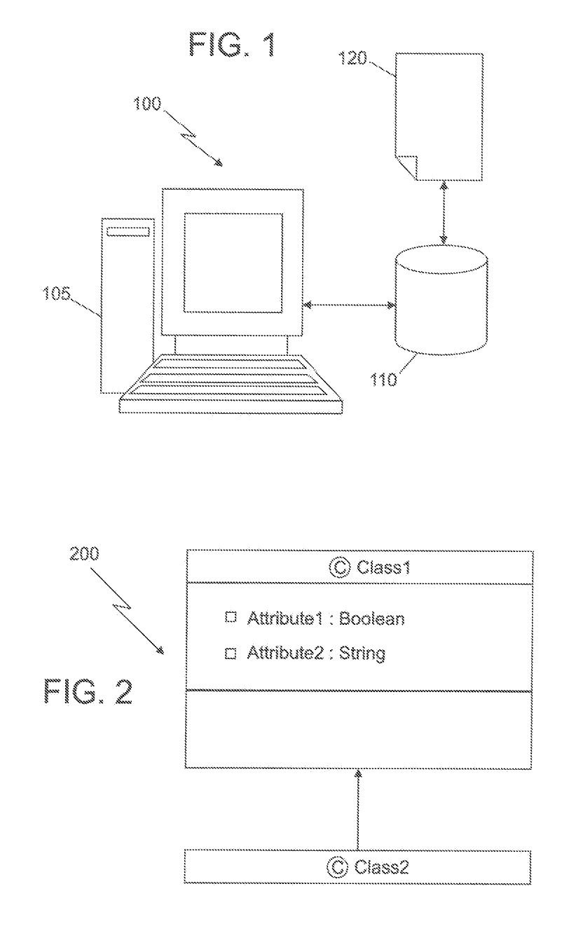

Turning now to the drawings in greater detail, it will be seen that in FIG. 1 there is FIG. 1 illustrates an exemplary system 100 for in-place model attribute comparison. In exemplary embodiments, the system 100 includes a processing device 105 such as a computer, which includes a storage medium or memory 110. The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processing device 105. The system 100 can further include an in-place model attribute comparison tool 120 residing in the memory.

In exemplary embodiments, the systems and methods described herein provide a comparison of requested differences only and not a file-to-file comparison. As such, the user selects a portion inside a diagram and asks for the differences with an old version. Therefore, the user creates a context (i.e., at runtime) in which the user is interested in seeing the differences. For example, a “LimitedDiff” tool shows the differences for which the user asked and not for the entire file. In contrast, a user cannot a portion inside PowerPoint® and ask for differences with the older version. In PowerPoint®, the user must search/navigate for the lines of interest from the complete list of differences for the entire file. In the embodiments described herein the “LimitedDiff” tool shows the differences for the portion context defined by the user at runtime with its previous version. The ability to display only the requested differences in referred to as in-place comparison: seeing what has changed in a model while the user is modeling. The user can therefore see the differences between a current version and previous version of a selected model element while the user is inside a modeling tool, which shows the user the differences of the element of interest (i.e., only the differences of the elements of interest) without leaving the current IDE or opening up any external tool. It is appreciated that the model element(s) here can be a single or multiple number of class(es), usecase(s) or any other element defined in UML.

In exemplary embodiments, by using a hotkey and selecting (e.g., Ctrl+Selecting) a particular model element for few seconds shows the previous version of a model element, which occurs in-place as described above. The previous version of the selected model element is shown just above its current position allowing the user to have a visual comparison.

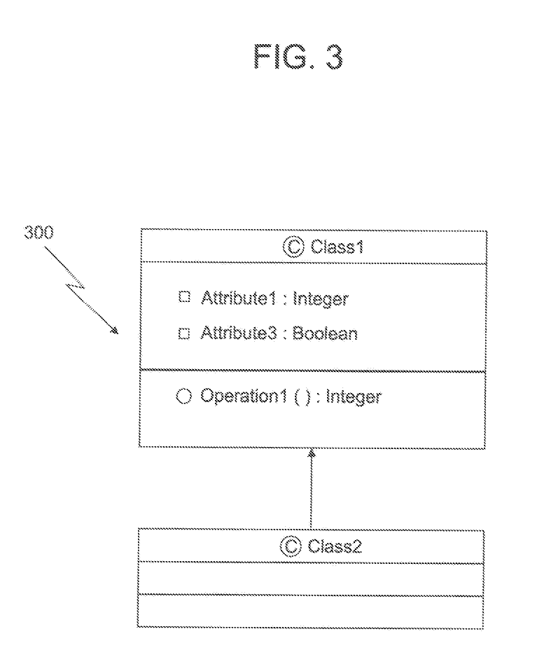

FIG. 2 illustrates a class diagram 200 (Initial Version) prior to a modification, in accordance with exemplary embodiments. In exemplary embodiments, the class diagram includes two classes, Class1 and Class2. Class1 has 2 attributes, Attribute1 and Attribute2, which are of type Boolean and String respectively, which is an initial version of class diagram present in a UML model. As the user performs modeling, many elements inside my mode are edited. In the example illustrated in FIG. 2, Class1 is one element in this model that is changed in appearance and attributes. FIG. 3 illustrates a class diagram 300 (Final Version) after modifications in accordance with exemplary embodiments. The modifications shown in the class diagram 300 are to Class1. In accordance with exemplary embodiments, using the “LimitedDiff” tool (e.g., depressing ctrl+selection for few seconds) on Class1 in FIG. 3, displays the difference between the current version and previous version.

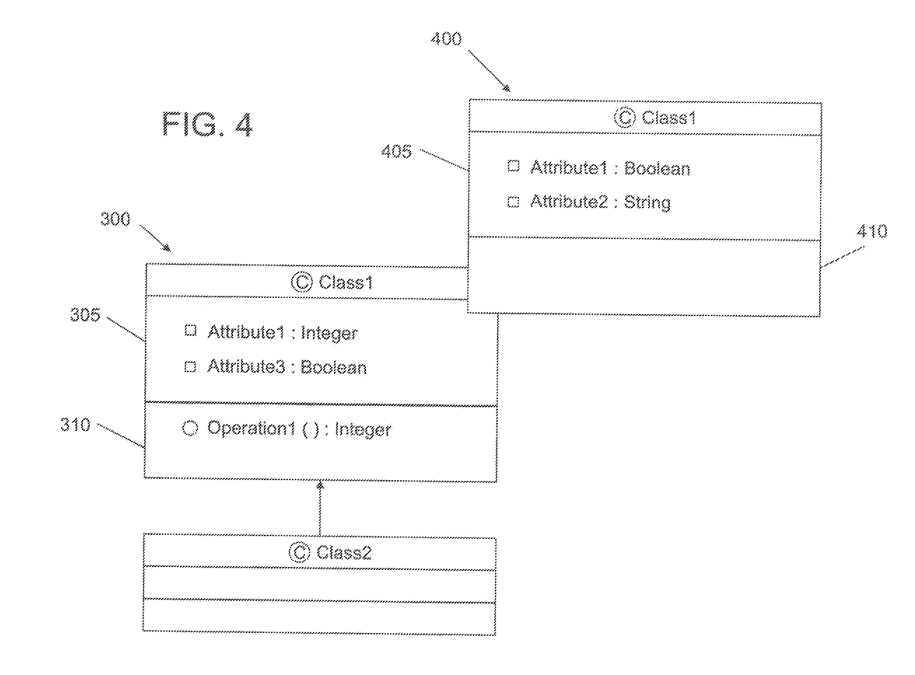

FIG. 4 illustrates the Final Version class diagram 300 of FIG. 3 with a differences window 400 illustrating the differences between the Initial Version class diagram 200 of FIG. 2 and the Final Version class diagram 300 of FIG. 3 in accordance with exemplary embodiments. In exemplary embodiments, as described, the differences are shown in the differences pop-up window 400 just above the class diagram 300. The class diagram 300 illustrates the modified/added attributes in a first window 305 and the current attributes in a current window 310. The differences pop-up window 400 illustrates deleted attributes in a first window 405 and previous attributes in a second window 410. As such, the user can immediately see the differences between the current model element of interest and its previous version. In exemplary embodiments, the differences pop-up window 400 disappears once the user releases the hot key combination of enabling the LimitedDiff tool, and the user sees is current model once again as shown in FIG. 3 in this example.

The systems and methods described herein can be implemented in RSA/RSM (Rational Software Architect). In exemplary embodiments, every model element is identified with a unique ID inside a model file. The model file stores information of all the model elements and Diagrams, which can be identified uniquely. When a user selects a model element and activates the LimitedDiff tool, the user can extract information particular to this model element (using the unique ID) from the previous version of model. The extracted information is represented back in the current model allowing the user to have a quick view between the two versions.

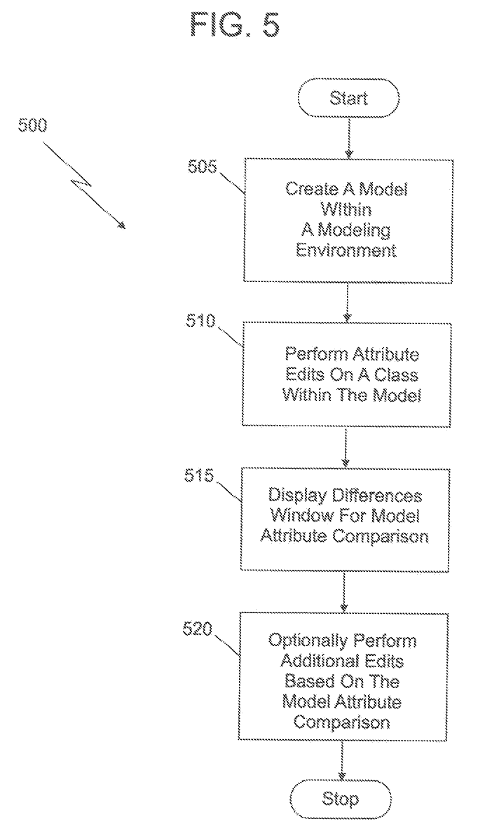

FIG. 5 illustrates an overall method 500 for performing an in-place comparison in accordance with exemplary embodiments. At step 505, the user creates a model within a modeling environment as described herein. At step 510, the user performs attribute edits on a class in the model within the modeling environment. At step 515, the user can display the differences between the Initial Version of the model and the Final Version of the Model in a differences window. At step 520, the user can perform additional edits on the model based on the model attribute comparison.

It is therefore appreciated that the systems and methods described herein provide a user with a comparison environment that can be displayed concurrently with the modeling environment providing an in-place comparison for a quick view of the differences. In addition, the user can replace a model element with the older version. The comparison tool can be used over a UML diagram to show the previous version of the diagram.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a computer system having a keyboard and a display, method for examining changes to a data model, the method comprising:
examining a computer model having a plurality of model attributes;
identifying each model attribute and assigning a unique identifier to each model attribute;
storing information about each uniquely identified model attribute;
collecting data related to edits performed on of each of the uniquely identified model attributes;
providing a user selectable comparison for each of the uniquely identified model attributes such that when a model attribute is selected, data particular to the model attribute is extracted using the unique identifier from a previous iteration of the model attribute; and
presenting the extracted data next to the current iteration of the model attribute to allow a visual comparison of the two iterations.

2. The method as claimed in claim 1 further comprising displaying a class model having Initial Version attributes in a first window displaying attributes having been at least one of added and modified.

3. The method as claimed in claim 2 further comprising displaying the class model having a second window displaying current attributes.

4. The method as claimed in claim 4 further comprising displaying a differences window by de[pressing a hotkey on the keyboard.

5. The method as claimed in claim 4 wherein the differences window includes a first window displaying deleted attributes and a second window displaying previous attributes.

6. A system for examining changes to a data model, the system comprising:
a computing device having a keyboard, a display and a memory having instructions to:
examine a computer model on the display, the computer model having a plurality of model attributes;
identify each model attribute and assigning a unique identifier to each model attribute;
store data about each uniquely identified model attribute in the memory;
collect data related to edits performed on of each of the uniquely identified model attributes;
provide a user selectable comparison for each of the uniquely identified model attributes such that when a model attribute is selected, data particular to the model attribute is extracted using the unique identifier from a previous iteration of the model attribute, the user selectable comparison being performed by depressing a hot key combination on the keyboard to display a differences window on the display; and
present the extracted data next to the current iteration of the model attribute to allow a visual comparison of the two iterations, the comparison being displayed in the differences window.
